(19) United States
(12) Patent Application Publication
(10) Pub. No.: US 2015/0055909 A1
(43) Pub. Date: Feb. 26, 2015

(54) REFURBISHED BEARING AND METHOD OF REPAIRING A BEARING

(71) Applicant: Tru-Marine Pte Ltd, Singapore (SG)

(72) Inventor: David Weng Seng LOKE, Singapore (SG)

(21) Appl. No.: 14/464,709

(22) Filed: Aug. 21, 2014

Related U.S. Application Data
(60) Provisional application No. 61/868,101, filed on Aug. 21, 2013.

(51) Int. Cl. C23C 24/10; F16C 33/14; B23K 26/34; F16C 33/64

(52) U.S. Cl. CPC C23C 24/106; F16C 33/64; F16C 33/14; B23K 26/34
USPC 384/625; 219/76.14; 219/76.12

(57) ABSTRACT

A method of refurbishing a bearing is disclosed. The method includes providing a bearing having a tube structure and inner and outer surfaces. The bearing is mounted onto a mounting unit and a cladding head of a laser cladding unit is positioned within a bore of the bearing. The cladding head forms laser cladding layers disposed on the inner surface of the bearing. The cladding layers increase a thickness of the bearing and reduce an internal diameter of the bearing.

### CROSS-REFERENCE TO RELATED APPLICATION

This application claims the priority benefit of U.S. Provisional Application Ser. No. 61/868,101, filed on Aug. 21, 2013. All disclosures are incorporated herewith by reference.

### BACKGROUND

Turbochargers form part of a complex force induction system and are commonly found in internal combustion engines of ships and boats. A turbocharger includes a shaft that connects a compressor wheel with an exhaust gas-driven turbine. The turbine often operates at high rotational speeds in a high-temperature environment, and relies on a bearing system to minimize friction between the rotating parts. Operational and mechanical stresses subject the bearings to deterioration and fatigue failure over time. Worn bearings are typically subjected to replacement or refurbishment to maintain the operational efficiency of the turbocharger. However, replacement bearings significantly increase operational costs and a reconditioned bearing is often inferior to a new bearing.

From the foregoing discussion, there is a need to improve bearing refurbishment techniques and reduce replacement costs.

### SUMMARY

Embodiments generally relate to marine turbocharger bearings and methods for refurbishing marine turbocharger bearings. In one embodiment, a method of refurbishing a bearing is disclosed. The method includes providing a bearing having a tube structure and inner and outer surfaces. The bearing is mounted onto a mounting unit and a cladding head of a laser cladding unit is positioned within a bore of the bearing. The cladding head forms laser cladding layers disposed on the inner surface of the bearing. The cladding layers increase a thickness of the bearing and reduce an internal diameter of the bearing.

In another embodiment, a refurbished bearing is disclosed. The bearing includes a metal bearing having a tube structure and inner and outer surfaces. An overlay is disposed on the inner surface and forms an interface with the underlying metal substrate through a metallurgical bond formed using a laser cladding process. The laser clad overlay provides an increased functional performance and strength over the underlying metal substrate. The laser clad overlay includes a homogenous microstructure devoid of cracks and heat affect zones.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows a three-dimensional view of an embodiment of a bearing;

FIGS. 2A-2B show an embodiment of a tool for forming a cladding layer;

FIG. 2C shows a three-dimensional view of an exemplary embodiment of a workpiece;

FIG. 3 shows a three-dimensional view of an exemplary embodiment of an internal cladding unit;

FIGS. 4A-4C show cross-sectional views of multiple cladding layers; and

FIG. 5 shows a graphical profile of an embodiment of a cladding layer.

### DESCRIPTION

Embodiments generally relate to refurbished marine turbocharger bearings. Bearings are refurbished to original specifications, enabling continued use in a turbocharger system. Refurbished bearings avoid the need to replace bearings, significantly reducing operating costs of marine turbochargers.

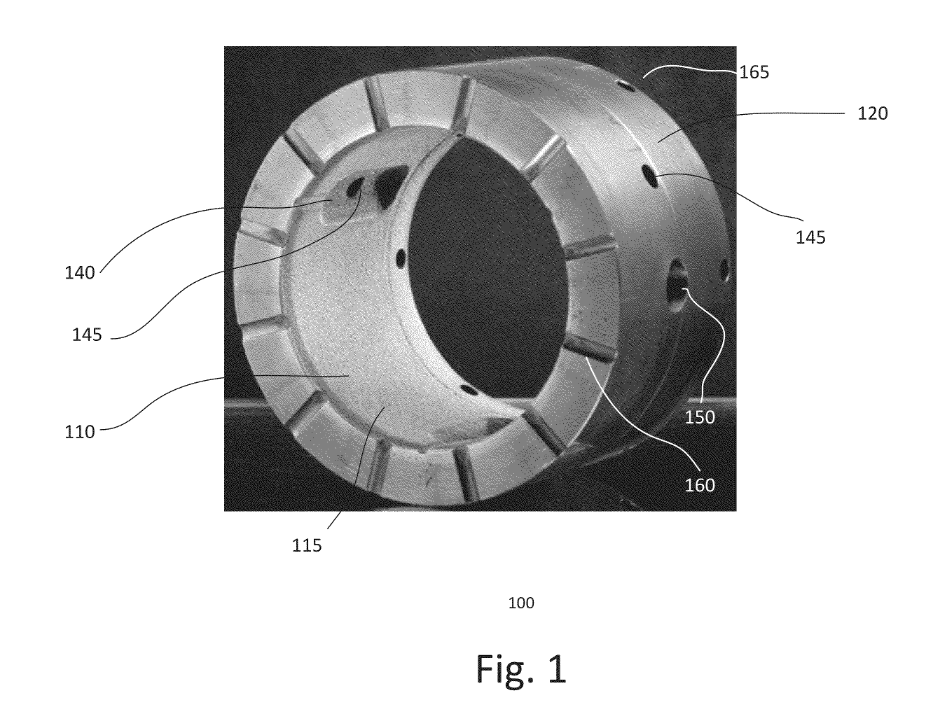

FIG. 1 shows a three-dimensional view of an embodiment of a refurbished marine turbocharger bearing 100. The bearing may be formed of a metallic material. For example, the bearing may be formed of bronze. The bronze may be a copper-tin alloy. In one embodiment, the bearing material provides for a hot forged bearing with high strength and good corrosion resistance. For example, the bearing may be formed of alloys composed of materials such as silicon, manganese, tin, lead or a combination thereof. Other types of bearing materials may also be useful. For example, the bearing material may also include lead-free, highly resistant special brass with good corrosion-resistance and good machinability.

As shown, the bearing is a sleeve bearing having a tube structure. The bearing, for example, includes a tube or ring shaped structure having an inner opening 115. The ring shaped structure includes an inner surface 110 and an outer surface 120. The inner surface, for example, forms the inner opening. The inner surface has an inner diameter (ID) and the out surface has an outer diameter (OD). The dimensions of the bearing, for example, may be about 160 mm for OD, about 80 mm for ID with a length of about 100 mm. Bearings with other dimensions may also be useful. The dimensions may depend on the size of the turbocharger and turbine shaft dimensions.

On the inner surface of the bearing may be cavities 140. A cavity may include a through hole 145. The through hole extends through the bearing. For example, the through hole enables communication between the cavity and the outer bearing surface. The through holes are, for example, oil feed holes. Grooves 160 are disposed on a first side surface of the bearing. The grooves extend from the inner surface to the outer surface. For example, the first side surface forms a thrust surface. Additionally, through holes 165 are disposed proximate to the second side of the bearing. As shown, the through holes 165 are distributed evenly around the bearing. The through holes 165, for example, function to locate the bearing in the bearing housing.

The bearing, when fitted to the turbocharger, has its outer surface clamped. For example, the bearing is mounted to a bearing mounting block of the turbocharger. The bearing mounting block, for example, includes a bearing housing. A shaft of the turbine is fitted through the inner opening or bearing bore. Although one bearing is shown, it is to be understood that the turbocharger may include multiple bearings fitted on the shaft. A specified distance or gap is disposed between the ID and OD of the turbine shaft. During operation of the turbocharger, oil is continuously fed through the oil feed holes, filling the gap. Excess oil is dispelled through the sides of the bearing. The gap remains continuously filled by circulating oil through the through holes, into the gap, and dispelled through sides of the bearing. This enables the shaft to rotate essentially without friction.

However, operational and mechanical stresses subject the bearings to deterioration. For example, excessive wear from use may cause damage to the bearing, such as scratches to form on the inner surface of the bearing. Other types of damages, such as reducing the thickness of the bearing material from the inner surface may also occur. Damage due to bearing wear causes the ID of the bearing to be out of specification. The ID, in such cases, may be larger than specification due to scratches and reduction of bearing material. This may damage or affect the efficiency of the turbocharger, causing it to operate inefficiently. In extreme cases, damage may cause the turbocharger break down or become inoperable.

In one embodiment, the inner surface of the refurbished bearing includes a cladding layer. The cladding layer is disposed on the inner surface of the base bearing. For example, the base bearing is the original bearing whose inner surface has been worn out of specification. For example, the ID of the original bearing is out of specification. In one embodiment, the inner surface of the base bearing may be machined to remove surface scratches before cladding. The cladding layer, for example, covers the complete inner surface of the base bearing. In one embodiment, the cladding layer is the same material as the base bearing. The cladding layer may be formed of bronze. For example, the cladding layer may be CuSn₅Pb₂₀. Other bronze cladding layers, such as CuZn₃₇Mn₃Al₂PbSi, may also be useful. Other types of cladding layers materials may also be useful. For example, a cladding layer having different material to the base bearing, such as lead-free, high strength brass with good corrosion resistance may also be useful. Preferably, the cladding layer is formed of the same material as the base bearing.

In one embodiment, the base bearing material determines the cladding material selection and compatibility. For example, the cladding layer includes materials with good weldability and suitable expansion coefficient to the base bearing. Other factors may also determine the cladding material. For example, the cladding materials may include materials which confer equal or superior performance factors, such as wear resistance, corrosion resistance and hardness, over the base bearing.

The cladding layer may have a hardness in the range of 120-130 HV03. The hardness of the cladding layer may be due to fine microstructures of the cladding layer. Other material hardness values of the cladding layer may also be useful. The cladding layer may be about 0.5-1.0 mm thick. Providing a cladding layer with other thicknesses may also be useful. For example, providing a cladding layer with a thickness up to about 3 mm may also be useful. In some embodiment, the cladding layer may include multiple cladding layers. For example, the cladding layer may include 2 or more cladding layers. The multitude of cladding layers result in increasing bearing thickness and reduce the ID of the refurbished bearing to be smaller than specification.

In one embodiment, a computer numerical control (CNC) turning continues to process the refurbished bearing to be according to specification. For example, the CNC turning includes a boring and smoothing process which removes excess cladding layers and sizes the ID of the bearing according to specification.

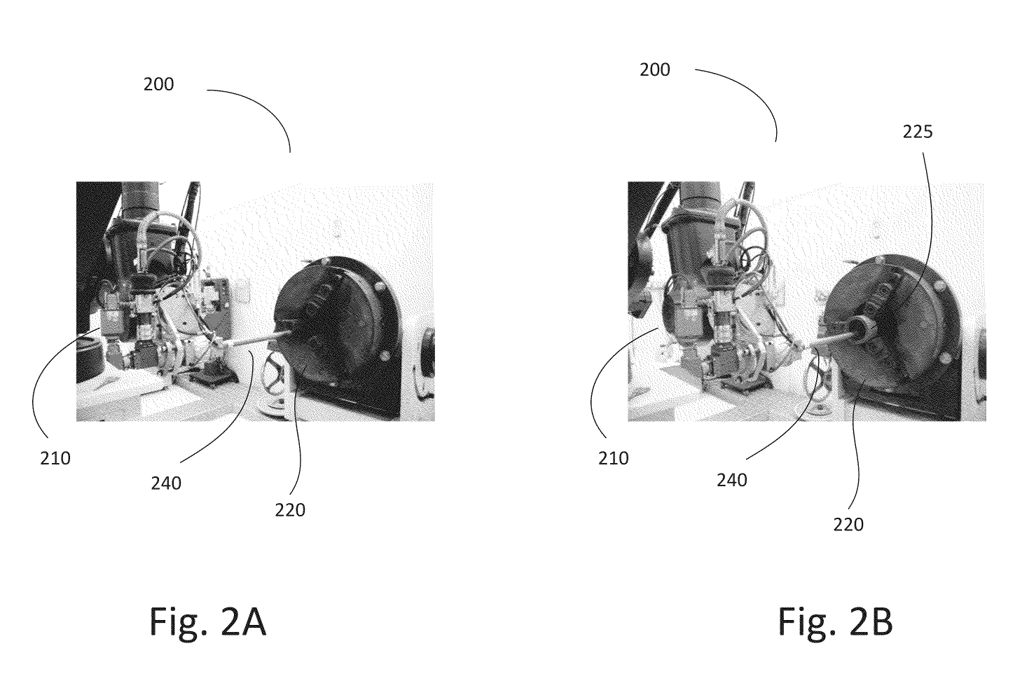

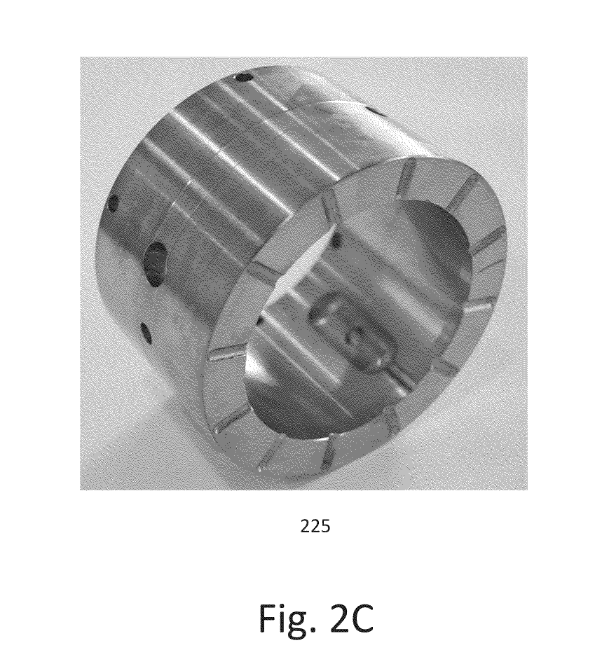

An experiment was conducted for forming a cladding layer on the surface of a bronze tube which represents a bearing. FIG. 2A shows an embodiment of a tool 200 employed for forming the cladding layer on internal or inner surface of a workpiece 225, such as a bearing for a marine turbocharger. An exemplary workpiece is illustrated in FIG. 2C. The tool, for example, is set up to form cladding layers on the inner surface of a workpiece. In one embodiment, the tool includes a workpiece mount 220. The mount includes a mounting unit for mounting the workpiece 225 for cladding. The mount, for example, mounts a bearing to be refurbished. The mounting units, for example, enable mounting of various types of marine turbocharger bearings for cladding. The mount, for example, is mounted onto a multi-axes work station. The work station, for example, may be a 6-axis work station. Other types of work stations may also be useful. The work station includes a motor for rotating the bearing mount. The motor should be capable of rotating the bearing mount with the workpiece up to about 100 rpm/min.

In the case of the experiment, the workpiece is a bronze tube 225 mounted onto the mount, as shown in FIG. 2B. The bronze tube is a CuSn5Pb20 tube. The bronze tube has an ID of 78.5 mm, OD of 101 mm and length of 76 mm. The material and dimensions, for example, may correspond to a bearing to be cladded. Other materials or dimensions may also be useful. For purposes of the experiment, a cladding layer is formed on the inner surface of the bronze tube. For the case of refurbishing a base bearing, the workpiece is a base bearing.

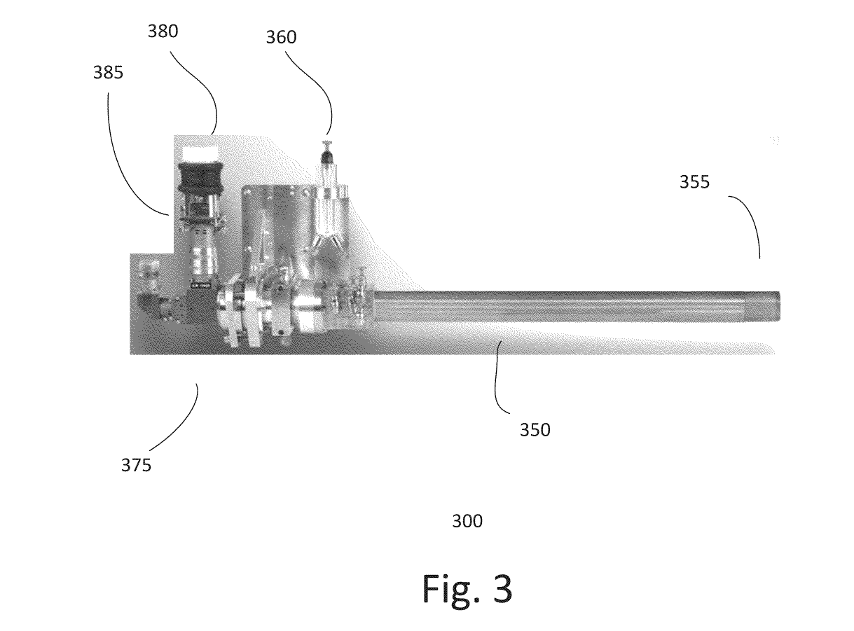

The tool includes an internal cladding unit 240. FIG. 3 shows a three-dimensional view of an exemplary embodiment of an internal cladding unit 300 in detail. The cladding unit includes a stable and rigid cladding head 350 having a source end 375 and head end 355. For example, the cladding unit includes a bronze and copper cladding head 350. In one embodiment, the cladding head includes a hollow cladding shaft. The cladding shaft, for example, enables communication between the source and head ends. Located about the head end 355 are outlets or nozzles for a cladding power source 380 and a cladding source material (powder) which are used to form a cladding layer. The cladding power source 380 is disposed about the source end of the cladding shaft. The source and head ends, for example, are opposite ends of the cladding head. The cladding power source, in one embodiment, is a laser source. In one embodiment, the laser source is a 2 KW YAG fiber laser. Other types of laser sources may also be useful. For example, having a diode laser as a laser source may also be useful. In one embodiment, the laser source, delivers a consistent laser through fiber cable to an optical system 385 which directs the laser from the source end to the head end through the cladding shaft.

In one embodiment, the optical system 385 includes lenses and mirrors for directing the laser beam from the laser source towards the head. For example, the optical system includes collimating and focusing lenses to produce a specific beam spot. In one embodiment, the beam spot is directed onto the inner surface (mirror) of the cladding nozzle for the workpiece to be cladded. For example, the mirror of the cladding nozzle further directs the beam spot onto the inner surface of the bearing for melting the base material and melding the cladding material to form the cladding layer. The minimum thickness of the cladding layer formed is, for example, 0.2 mm.

The cladding unit, for example, may be a cladding head developed by Fraunhofer ILT of Germany. Other types of cladding units may also be useful. The cladding unit, in one embodiment, is designed to clad a bearing having a minimum bore size of 30 mm. Providing cladding units for cladding other sizes may also be useful.

The cladding unit includes a source feeder for providing the cladding material to the head end for cladding the inner surface of the base bearing. In one embodiment, the source feeder is a powder feeder 360. The powder feeder 360, for example, provides cladding material which is disposed onto a melted portion of the inner surface of the bearing to form a cladding layer. For example, a carrier gas, such as Argon, delivers cladding material to the powder nozzle through a powder splitter. The powder splitter, for example, provides communication between the powder feeder and powder nozzle. Other types of source feeder may also be useful.

Referring back to FIG. 2, the cladding unit may be mounted onto a cladding head mount 210 of the tool. The cladding head mount facilitates moving the cladding head unit into position for cladding. For example, the head mount may be a multi-axes head mount for positioning the cladding head unit.

In forming the cladding layer, the cladding head is positioned for cladding. Positioning the cladding head for cladding may be achieved by positioning the workpiece (or base bearing) using the multi-axes workstation and/or cladding head mount. In one embodiment, the cladding head end is positioned over the inner surface of the workpiece before initiating the cladding process. The cladding process, for example, includes rotating the bearing mount to rotate the workpiece while a laser beam spot melts the base material of the workpiece and a source feeder provides cladding material disposed onto the melted base material to form one or more cladding layers. The cladding process, for example, forms laser clad overlays on the complete inner surface of the workpiece.

Exemplary selections of cladding parameters were sampled based on experimental design requirements. In some embodiments, the parameters include different component values. For example, different component values define different sample parameters. As an illustration, the parameter components include laser power at laser source (P_{L}) and at workpiece (P_{W}), process speed (V_{P}), power mass flow (M_{P}), feeding gas flow rate (V_{FG}) and pressure (P_{FG}), shielding gas flow rate (V_{SG}) and pressure (P_{SG}), laser defocusing distance (def), distance of power nozzle to workpiece (S_{PD}), displacement between tracks (X), and the number of tracks (n). Table 1 below shows exemplary component values of different parameter samples, such as parameter samples 4-7.

TABLE 1

Sample

| | 4 | 5 | 6 | 7 |
|---|---|---|---|---|
| P_{L} [%] | 55 | 55 | 55 | 60 |
| P_{W} [W] | 1600 | 1600 | 1600 | 1730 |
| V_{P} [mm/min] | 600 | 600 | 800 | 800 |
| M_{P} [g/min] | 5/12 | 7/15 | 8/17 | 9/18 |
| V_{FG} [l/min] | 35 | 35 | 35 | 35 |
| P_{FG} [bar] | 1 | 1 | 1 | 1 |
| V_{SG} [l/min] | 30 | 30 | 30 | 30 |
| P_{SG} [bar] | 3 | 3 | 3 | 3 |
| def [mm] | 0 | 0 | 0 | 0 |
| S_{PD} [mm] | 8.2 | 8.2 | 8.2 | 8.2 |
| X [mm] | 1.4 | 1.4 | 1.4 | 1.4 |
| n | 8 | 8 | 8 | 8 |

As shown, experimental variables include laser power, process speed and powder mass flow. The experimental variables and constants are, for example, determined through experimentations. In one embodiment, sample 6 is the preferred cladding parameter for a bronze workpiece. For example, sample 6 provides better cladding uniformity devoid of cracks, minimum porosity and a good dilution. The preferred parameter is defined by the experimental designs, such as the internal cladding unit and bronze tube. Other cladding parameters may also be useful. For example, other cladding parameters defined by the type of cladding tool and/or workpiece, such as the type of laser source, source feeder and/or material of workpiece, may also be useful.

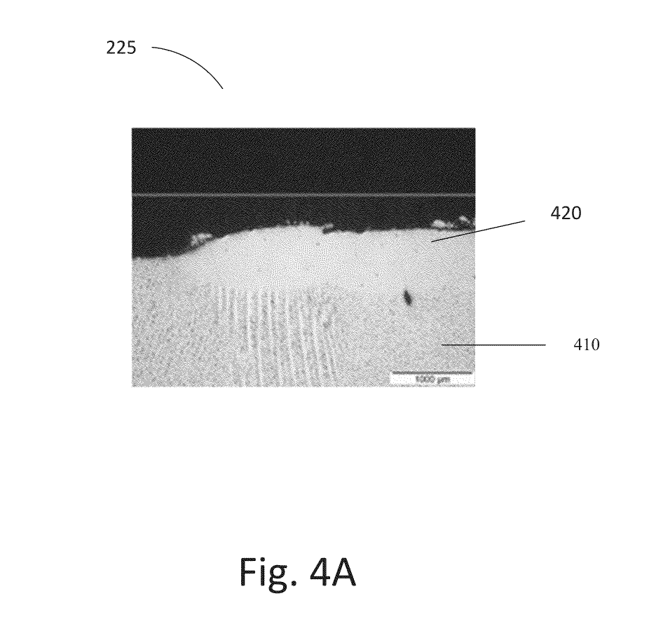

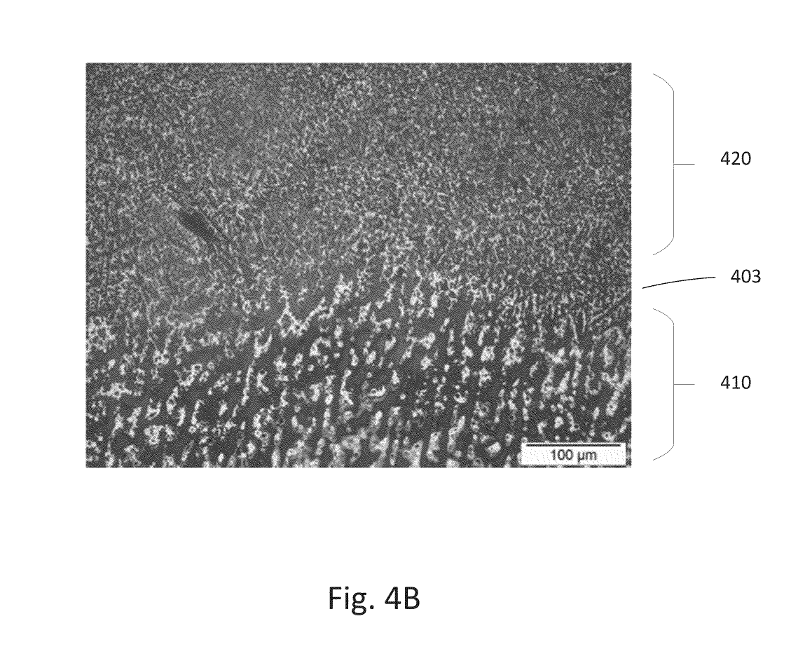

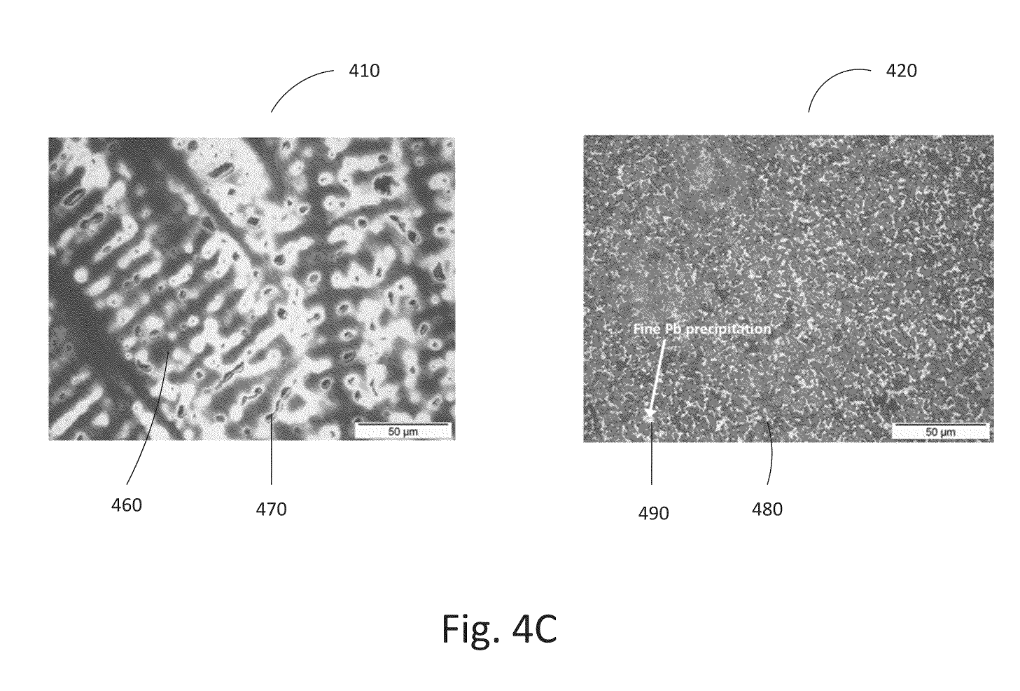

FIGS. 4A-4C show cross-sectional views of multiple cladding layers formed across the surface of a workpiece 225. For example, the various cladding layers are formed across the ID of a bronze tube. In one embodiment, the cladding layers are formed from experimentally defined parameters. The parameters are, for example, defined by the cladding tool and workpiece.

FIG. 4A shows a cross-sectional overview of the cladding layers 420 and the inner surface of the bronze tube (or base substrate) 410. In one embodiment, the cladding process forms overlapping cladding layers across the inner surface. In one embodiment, the cladding layers 420 have a thickness of about 400-500 μm. Other cladding thickness may also be useful. For example, a cladding thickness of up to about 1.5 mm may also be useful. As shown, the cladding layers 420 include a homogenous microstructure devoid of cracks. In one embodiment, the material of the cladding layers 420 is similar to the base substrate 410. Other cladding materials may also be useful. For example, having a cladding material different to the base substrate may also be useful. In one embodiment, the material composition of the cladding layers 420 is different from the base substrate 410. For example, the composition of the cladding layer 420 is about half of the base substrate 410. Other cladding compositions may also be useful. For example, a cladding composition similar to the base substrate 410 may also be useful.

FIG. 4B shows a magnified cross-sectional view of the microstructures of the cladding layer 420 and base substrate 410. In one embodiment, forming the cladding layers forms an interface layer 403 between the cladding layers and base substrate. The cladding layers form, for example, a compact and uniform interface with the base substrate. In one embodiment, the interface forms a metallurgical bond between the cladding layers and base substrate. The metallurgical bond, for example, provides better overlay resistance to external physical loads and stresses as compared to mechanical bonds. For example, laser clad overlays have better resistance against tear off, fracture, or spall.

The in-situ microstructure of the cladding 420 and base substrate 410 layers includes a matrix 460. In one embodiment, the matrix includes pockets embedded with precipitate 470. For example, the microstructure includes lead (Pb) precipitate distributed within a bronze alloy matrix. As shown in FIG. 4C, the microstructure of the cladding layers 420 have a denser matrix 480 than the base substrate 410. For example, the cladding layers have finer microstructure 480 and precipitate distribution 490. The increased density of the cladding layers 420, for example, provides improved toughness over the base substrate.

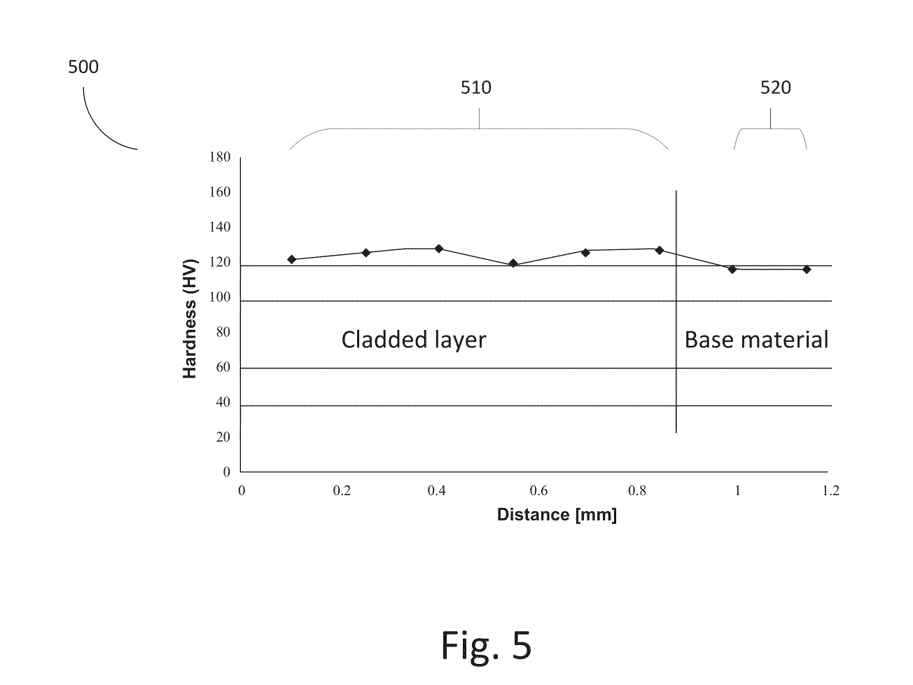

FIG. 5 shows a graphical profile of an embodiment of a cladding layer. For example, FIG. 5 shows a hardness profile 500 of cladding layers formed from experimentally defined cladding parameters. In one embodiment, the cladding layers are formed across the ID of a bronze tube. The cladding layers are similar to that described in FIGS. 4a-4c. Common elements may not be described or described in detail.

A hardness test defines the hardness profile 500 which illustrates the hardness of the cladded layer 510 and base substrate 520. In one embodiment, the hardness test employs an indentation test. For example, the hardness test employs a Vickers microindentation test (HV₃₀₀). Employing other hardness tests may also be useful. As shown, the hardness of the cladding layers 510 ranges about 120-130 HV₃₀₀ and the hardness of the base substrate 520 ranges less than 120 HV₃₀₀. The improved hardness profile of the cladding layer 510 is attributed to the finer microstructure deposited by the cladding process. The narrow variations in hardness define a cladding layer devoid of heat affect zones.

As illustrated, the exemplary cladding parameters provide a cladding layer with increased functional performance and strength over the underlying base substrate. A fine layer of cladding material with homogenous microstructure is deposited over a base substrate. The microstructure, for example, includes a copper-tin alloy matrix with uniform distribution of precipitous elements. This enables formation of a cladding layer with increased hardness, reduced porosity and substantially devoid of cracks. In addition, laser clad overlays can withstand significant abrasion and direct impact.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method of cladding a bearing comprising:
providing a bearing having a tube structure, the bearing comprises inner and outer surfaces;
mounting the bearing onto a mounting unit;
positioning a cladding head of a laser cladding unit within a bore of the bearing, wherein the cladding head comprises a source end and a head end; and
forming laser cladding layers disposed on the inner surface of the bearing, wherein the cladding layers increase a thickness of the bearing and reduce an internal diameter of the bearing.

2. The method of claim 1 wherein the head end comprises a cladding nozzle and a powder nozzle.

3. The method of claim 2 wherein the head end is in communication with the source end through a cladding shaft.

4. The method of claim 2 wherein the cladding and powder nozzle is positioned over the inner surface of the bearing.

5. The method of claim 4 wherein the cladding nozzle disposes a beam spot onto a cladding surface and the powder nozzle disposes a cladding material onto the cladding surface.

6. The method of claim 1 wherein the source end comprises a laser source, a source feeder and an optical system.

7. The method of claim 6 wherein the laser source delivers a laser through a fiber cable to the optical system.

8. The method of claim 7 wherein the optical system comprises collimating and focusing lens.

9. The method of claim 1 wherein the bearing comprises copper-tin alloy.

10. The method of claim 9 wherein the material of the cladding layers is similar to the base bearing.

11. The method of claim 9 wherein the material of the cladding layers is different to the base bearing.

12. The method of claim 1 comprising processing the inner surface to remove scratches before forming the cladding layers.

13. The method of claim 1 comprising processing the cladding layers to remove excess cladding layers.

14. The method of claim 13 wherein the process comprises computer numerical control turning.

15. The method of claim 1 wherein the laser cladding unit is mounted onto a cladding head mount.

16. The method of claim 15 wherein positioning the cladding head within the bearing bore comprises positioning the cladding head mount or a bearing mounting unit.

17. A method of cladding a bearing comprising:
providing a bearing having a tube structure, the bearing comprises inner and outer surfaces;
processing the bearing to remove scratches on the inner surface of the bearing;
mounting the bearing onto a mounting unit;
positioning a cladding head of a laser cladding unit within a bore of the bearing, wherein the cladding head comprises a source end and a head end;
forming multiple laser cladding layers disposed on the inner surface of the bearing, wherein the cladding layers increase a thickness of the bearing and reduce an internal diameter of the bearing; and
processing the laser cladded bearing to remove excess cladding layers, wherein the process provides an internal bearing diameter according to specification.

18. The method of claim 17 wherein the cladding layer material is similar to the base substrate.

19. The method of claim 18 wherein the cladding layer material is different to the base substrate.

20. A refurbished bearing comprising:
a metal bearing having a tube structure, wherein the bearing comprises inner and outer surfaces; and
an overlay disposed on the inner surface, wherein the overlay forms an interface with the underlying metal substrate through a metallurgical bond formed using a laser cladding process, wherein
the laser clad overlay provides an increased functional performance and strength over the underlying metal substrate, and
the laser clad overlay comprises a homogenous microstructure devoid of cracks and heat affect zones.
